(19) United States
(12) Patent Application Publication
(10) Pub. No.: US 2022/0141675 A1
(43) Pub. Date: May 5, 2022

(54) REFERENCE SIGNAL TRANSMISSIONS FOR MULTI-BEAM OPERATION

(71) Applicant: QUALCOMM Incorporated, San Diego, CA (US)

(72) Inventors: Shay Landis, Hod Hasharon (IL); Ran Berliner, Kfar-Aviv (IL); Yehonatan Dallal, Kfar Saba (IL)

(21) Appl. No.: 17/090,845

(22) Filed: Nov. 5, 2020

(51) Int. Cl. H04W 16/28; H04L 5/00; H04L 1/00; H04W 28/06

(52) U.S. Cl. CPC H04W 16/28; H04W 28/06; H04L 1/0029; H04L 5/0051

(57) ABSTRACT

Methods, systems, and devices for wireless communications are described. Generally, the described techniques provide for using a same antenna port to transmit or receive reference signals on different beams. A network may determine different directional beams to use to transmit different data streams, and the network may transmit each data stream using a different directional beam. The network may also transmit reference signals with the different data streams using a same antenna port, and a user equipment (UE) may receive the reference signals with the different data streams using a same antenna port. Because a same antenna port may be used for transmitting or receiving reference signals with different data streams, the reference signals may occupy the same time and frequency resources, and the overhead of reference signal transmissions may be minimized.

### FIELD OF TECHNOLOGY

The following relates to wireless communications, including reference signal transmissions for multi-beam operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may support communications with a base station using multiple beams (e.g., multi-beam operation). In such systems, a base station may schedule downlink transmissions to a UE or uplink transmissions from the UE on any of a number of beams. Improved techniques for supporting multi-beam operation in a wireless communications system may be desirable.

### SUMMARY

The described techniques relate to improved methods, systems, devices, and apparatuses that support reference signal transmissions for multi-beam operation. Generally, the described techniques provide for using a same antenna port to transmit or receive reference signals on different beams. A network may determine different directional beams to use to transmit different data streams, and the network may transmit each data stream using a different directional beam. The network may also transmit reference signals with the different data streams using a same antenna port, and a user equipment (UE) may receive the reference signals with the different data streams using a same antenna port. Because a same antenna port may be used for transmitting or receiving reference signals with different data streams, the reference signals may occupy the same time and frequency resources, and the overhead of reference signal transmissions may be minimized.

A method for wireless communication is described. The method may include determining a first directional beam to use to transmit a first data stream to a UE and a second directional beam to use to transmit a second data stream to the UE and transmitting a first reference signal associated with the first data stream via the first directional beam over an antenna port and a second reference signal associated with the second data stream via the second directional beam over the antenna port.

An apparatus for wireless communication is described. The apparatus may include a processor, memory in electronic communication with the processor, and instructions stored in the memory. The instructions may be executable by the processor to cause the apparatus to determine a first directional beam to use to transmit a first data stream to a UE and a second directional beam to use to transmit a second data stream to the UE and transmit a first reference signal associated with the first data stream via the first directional beam over an antenna port and a second reference signal associated with the second data stream via the second directional beam over the antenna port.

Another apparatus for wireless communication is described. The apparatus may include means for determining a first directional beam to use to transmit a first data stream to a UE and a second directional beam to use to transmit a second data stream to the UE and means for transmitting a first reference signal associated with the first data stream via the first directional beam over an antenna port and a second reference signal associated with the second data stream via the second directional beam over the antenna port.

A non-transitory computer-readable medium storing code for wireless communication is described. The code may include instructions executable by a processor to determine a first directional beam to use to transmit a first data stream to a UE and a second directional beam to use to transmit a second data stream to the UE and transmit a first reference signal associated with the first data stream via the first directional beam over an antenna port and a second reference signal associated with the second data stream via the second directional beam over the antenna port.

In some examples of the method, apparatuses, and non-transitory computer-readable medium described herein, transmitting the first reference signal and the second reference signal over the antenna port may include operations, features, means, or instructions for transmitting the first reference signal and the second reference signal on a same set of time-frequency resources. Some examples of the method, apparatuses, and non-transitory computer-readable medium described herein may further include operations, features, means, or instructions for transmitting a first transmission over a set of time-frequency resources via the first directional beam and a second transmission over the set of time-frequency resources via the second directional beam, the first transmission including the first data stream and the first reference signal and the second transmission including the second data stream and the second reference signal.

In some examples of the method, apparatuses, and non-transitory computer-readable medium described herein, transmitting the first transmission via the first directional beam and the second transmission via the second directional beam may include operations, features, means, or instructions for transmitting the first transmission via the first directional beam from a first transmission and reception point and transmitting the second transmission via the second directional beam from a second transmission and reception point. In some examples of the method, apparatuses, and non-transitory computer-readable medium described herein, transmitting the first transmission via the first directional beam and the second transmission via the second directional beam may include operations, features, means, or instructions for transmitting the first transmission via the first directional beam and the second transmission via the second directional beam from a same antenna panel.

In some examples of the method, apparatuses, and non-transitory computer-readable medium described herein, the first reference signal and the second reference signal include demodulation reference signals, and the antenna port includes a demodulation reference signal port. In some examples of the method, apparatuses, and non-transitory computer-readable medium described herein, the first reference signal transmitted via the first directional beam and the second reference signal transmitted via the second directional beam include a same set of transmitted symbols. In some examples of the method, apparatuses, and non-transitory computer-readable medium described herein, each of the first data stream and the second data stream includes a set of multiple layers.

A method for wireless communication at a UE is described. The method may include determining a first directional beam for receiving a first data stream from a base station and a second directional beam for receiving a second data stream from the base station and receiving a first reference signal associated with the first data stream via the first directional beam over an antenna port and a second reference signal associated with the second data stream via the second directional beam over the antenna port.

An apparatus for wireless communication at a UE is described. The apparatus may include a processor, memory in electronic communication with the processor, and instructions stored in the memory. The instructions may be executable by the processor to cause the apparatus to determine a first directional beam for receiving a first data stream from a base station and a second directional beam for receiving a second data stream from the base station and receive a first reference signal associated with the first data stream via the first directional beam over an antenna port and a second reference signal associated with the second data stream via the second directional beam over the antenna port.

Another apparatus for wireless communication at a UE is described. The apparatus may include means for determining a first directional beam for receiving a first data stream from a base station and a second directional beam for receiving a second data stream from the base station and means for receiving a first reference signal associated with the first data stream via the first directional beam over an antenna port and a second reference signal associated with the second data stream via the second directional beam over the antenna port.

A non-transitory computer-readable medium storing code for wireless communication at a UE is described. The code may include instructions executable by a processor to determine a first directional beam for receiving a first data stream from a base station and a second directional beam for receiving a second data stream from the base station and receive a first reference signal associated with the first data stream via the first directional beam over an antenna port and a second reference signal associated with the second data stream via the second directional beam over the antenna port.

In some examples of the method, apparatuses, and non-transitory computer-readable medium described herein, receiving the first reference signal and the second reference signal over the antenna port may include operations, features, means, or instructions for receiving the first reference signal and the second reference signal on a same set of time-frequency resources. Some examples of the method, apparatuses, and non-transitory computer-readable medium described herein may further include operations, features, means, or instructions for receiving a first transmission over a set of time-frequency resources via the first directional beam and a second transmission over the set of time-frequency resources via the second directional beam, the first transmission including the first data stream and the first reference signal and the second transmission including the second data stream and the second reference signal.

In some examples of the method, apparatuses, and non-transitory computer-readable medium described herein, receiving the first transmission via the first directional beam and the second transmission via the second directional beam may include operations, features, means, or instructions for receiving the first transmission via the first directional beam on a first antenna panel and receiving the second transmission via the second directional beam on a second antenna panel. In some examples of the method, apparatuses, and non-transitory computer-readable medium described herein, receiving the first transmission via the first directional beam and the second transmission via the second directional beam may include operations, features, means, or instructions for receiving the first transmission via the first directional beam and the second transmission via the second directional beam on a same antenna panel.

In some examples of the method, apparatuses, and non-transitory computer-readable medium described herein, the first reference signal and the second reference signal include demodulation reference signals, and the antenna port includes a demodulation reference signal port. In some examples of the method, apparatuses, and non-transitory computer-readable medium described herein, the first reference signal received via the first directional beam and the second reference signal received via the second directional beam include a same set of transmitted symbols. In some examples of the method, apparatuses, and non-transitory computer-readable medium described herein, each of the first data stream and the second data stream includes a set of multiple layers.

### BRIEF DESCRIPTION OF THE DRAWINGS

FIG. 1 illustrates an example of a wireless communications system that supports reference signal transmissions for multi-beam operation in accordance with aspects of the present disclosure.

FIG. 2 illustrates an example of reference signal transmissions on different resources in accordance with aspects of the present disclosure.

FIG. 3 illustrates an example of a wireless communications system that supports reference signal transmissions for multi-beam operation in accordance with aspects of the present disclosure.

FIG. 4 illustrates an example of reference signal transmissions on the same resources in accordance with aspects of the present disclosure.

FIGS. 5 and 6 show block diagrams of devices that support reference signal transmissions for multi-beam operation in accordance with aspects of the present disclosure.

FIG. 7 shows a block diagram of a communications manager that supports reference signal transmissions for multi-beam operation in accordance with aspects of the present disclosure.

FIG. 8 shows a diagram of a system including a device that supports reference signal transmissions for multi-beam operation in accordance with aspects of the present disclosure.

FIGS. 9 and 10 show block diagrams of devices that support reference signal transmissions for multi-beam operation in accordance with aspects of the present disclosure.

FIG. 11 shows a block diagram of a communications manager that supports reference signal transmissions for multi-beam operation in accordance with aspects of the present disclosure.

FIG. 12 shows a diagram of a system including a device that supports reference signal transmissions for multi-beam operation in accordance with aspects of the present disclosure.

FIGS. 13 and 14 show flowcharts illustrating methods that support reference signal transmissions for multi-beam operation in accordance with aspects of the present disclosure.

### DETAILED DESCRIPTION

In some wireless communications systems, a user equipment (UE) may support communications with a network using multiple beams. Communications on some bands (e.g., FR2) may be based on narrow directional analog beams (e.g., using a phased array). Communications on higher frequency bands (e.g., FR4 and FR5) may utilize significantly narrower beams to overcome additional path loss that comes from using higher frequency carriers. As the beams become narrower, the spatial separation between the beams becomes better (e.g., increases).

Despite the improved spatial separation between beams at higher frequency bands. some wireless communications systems may employ further techniques for multiplexing transmissions on different beams. For instance, for communications between a UE and multiple transmission and reception points (TRPs), each TRP may transmit reference signals in different data streams to the UE using a different code division multiplexing (CDM) group. Further, the TRPs may transmit the reference signals in different data streams on different resources. Thus, as the number of beams increases, the overhead of reference signal transmissions may also increase, and less resources may be available for data.

As described herein, a wireless communications system may support efficient techniques for transmitting reference signals with different data streams with limited overhead. A network may determine different directional beams to use to transmit different data streams, and the network may transmit each data stream using a different directional beam. The network may also transmit reference signals with the different data streams using a same antenna port, and a UE may receive the reference signals with the different data streams using a same antenna port. Because a same antenna port may be used for transmitting or receiving reference signals with different data streams, the reference signals may occupy the same time and frequency resources, and the overhead of reference signal transmissions may be minimized.

Aspects of the disclosure introduced above are described below in the context of a wireless communications system. Examples of processes and signaling exchanges that support reference signal transmissions for multi-beam operation are then described. Aspects of the disclosure are further illustrated by and described with reference to apparatus diagrams, system diagrams, and flowcharts that relate to reference signal transmissions for multi-beam operation.

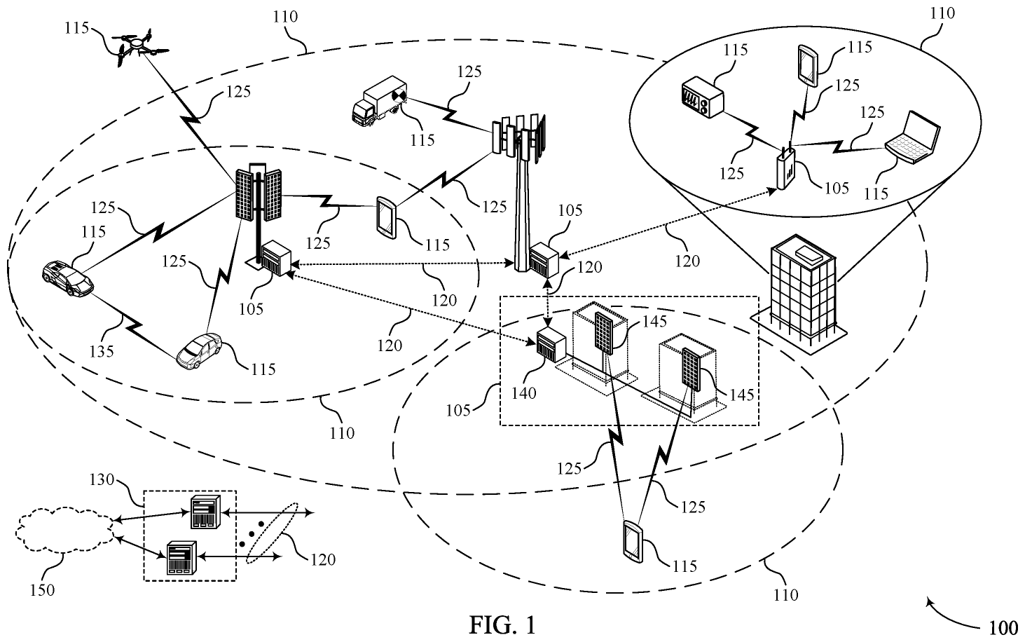

FIG. 1 illustrates an example of a wireless communications system 100 that supports reference signal transmissions for multi-beam operation in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105 (e.g., in a physical uplink control channel (PUCCH) or physical uplink shared channel (PUSCH)), or downlink transmissions from a base station 105 to a UE 115 (e.g., in a physical downlink control channel (PDCCH) or a physical downlink shared channel (PDSCH)). Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In wireless communications system 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array that may support transmission from one or more of multiple antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In wireless communications system 100, a UE 115 may support communications with a network using multiple beams. Communications on some bands (e.g., FR2) may be based on narrow directional analog beams (e.g., phased array). Communications on higher frequency bands (e.g., FR4 and FR5) may utilize significantly narrower beams to overcome additional path loss that comes from using higher frequency carriers. As the beams become narrower, the spatial separation between the beams becomes better (e.g., increases). Smart beam selection may allow massive MIMO using spatial division multiplexing (SDM) with very small interference between beams. Sub-THz technologies like lens antennas can allow a base station 105 to transmit multiple beams from a same panel. Thus, in addition to supporting multi-beam operation (e.g., multi-TRP) from different panels, higher frequency bands may also support multi-beam operation from the same panel.

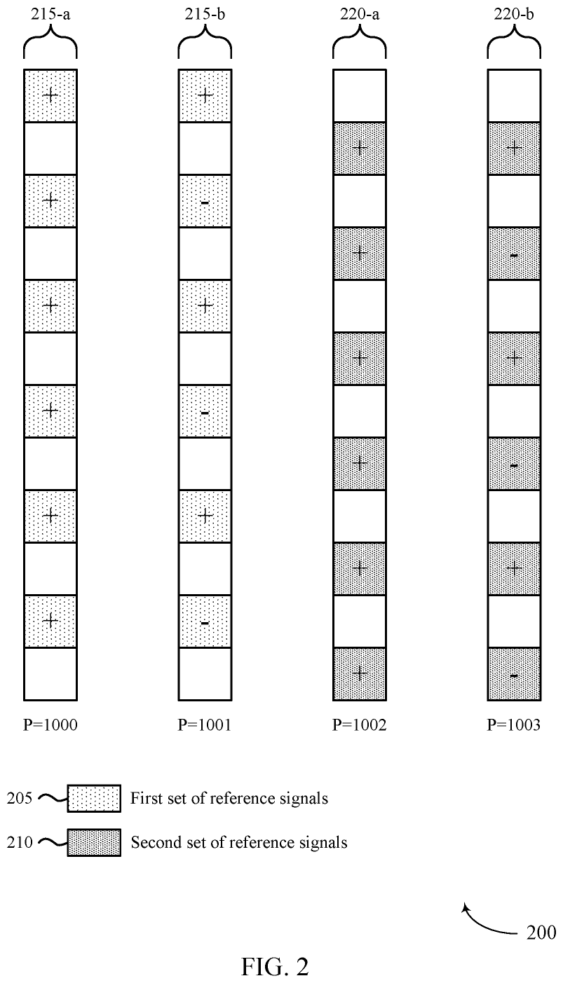

Despite the improved spatial separation between beams at higher frequency bands. some wireless communications systems may employ further techniques for multiplexing transmissions on different beams. For instance, for communications between a UE 115 and multiple transmission and reception points (TRPs), each TRP may transmit reference signals (e.g., demodulation reference signals (DMRSs)) in different data streams to the UE 115 using different code division multiplexing (CDM) groups. Further, the TRPs may transmit the reference signals in different data streams on different resources (e.g., different antenna ports). FIG. 2 illustrates an example of reference signal transmissions 200 on different resources in accordance with aspects of the present disclosure. Each TRP scheduled to transmit a data stream to a UE 115 may use a different CDM group. Antenna ports 1000 and 1001 and antenna ports 1002 and 1003 may form such CDM groups. Antenna ports 1000 and 1001 may be associated with a first set of resources while antenna ports 1002 and 1003 may be associated with a second set of resources.

In the example of FIG. 2, a network may be scheduled to transmit a first data stream using a first directional beam and a second data stream using a second directional beam. To allow a receiving UE 115 to correctly decode the first data stream and the second data stream, the network may transmit a first set of reference signals 205 with the first data stream using the first directional beam and a second set of reference signals 210 with the second data stream using the second directional beam. To multiplex the first set of reference signals 205 and the second set of reference signals 210, the network may transmit the first set of reference signals 205 and the second set of reference signals 210 using different CDM groups on different resources (e.g., each CDM group associated with a different antenna port).

In particular, the network may transmit the first set of reference signals 205 with a first polarization 215-a (e.g., vertical) and the second set of reference signals 210 with a first polarization 220-a (e.g., vertical) in a same symbol on different frequency resources. Similarly, the network may transmit the first set of reference signals 205 with a second polarization 215-b (e.g., horizontal) and the second set of reference signals 210 with a second polarization 220-b (e.g., horizontal) in a same symbol on different frequency resources. That is, in the case that there are two SDM streams with two layers (e.g., horizontal and vertical polarizations), antenna ports 1000 and 1001 may be allocated for the first directional beam and antenna ports 1002 and 1003 may be allocated for the second directional beam.

Because the frequency resources used for the first set of reference signals 205 and the second set of reference signals 210 may be interlaced, the first set of reference signals 205 and the second set of reference signals may span an entire frequency band used for transmitting the first data stream and the second data stream. As a result, the number of data streams that the network may transmit may be restricted. That is, in FIG. 2, the network may be unable to transmit additional data streams since the network may not have access to any more resources to transmit reference signals with the additional data streams. Such a restriction on multi-beam operation may result in reduced throughput in a wireless communications system. Further, even if there are no additional data streams to transmit, the overhead of the reference signal transmissions for the first data stream and the second data stream may limit the resources available for data, resulting in reduced throughput in a wireless communications system.

Wireless communications system 100 may support efficient techniques for transmitting reference signals with multiple data streams with limited overhead. In particular, the wireless communications system 100 may change DMRS mapping for multi-TRP from using different CDM groups to using the same time and frequency resources (e.g., overloading). Because transmissions of multiple beams from the same panel or different panels may have improved spatial separation (e.g., for higher frequency bands), the DMRSs associated with different streams on the same resources may be multiplexed in the spatial domain. Thus, the wireless communications system 100 may overload resources with DMRSs associated with different streams (e.g., use the same time and frequency resources for DMRSs associated with different streams).

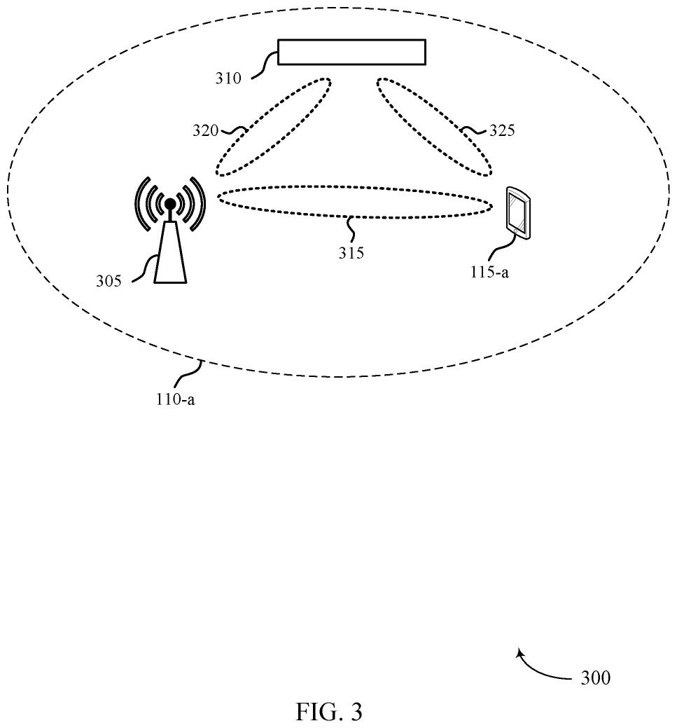

FIG. 3 illustrates an example of a wireless communications system 300 that supports reference signal transmissions for multi-beam operation in accordance with aspects of the present disclosure. The wireless communications system 300 includes a UE 115-a, which may be an example of a UE 115 described with reference to FIGS. 1 and 2. The wireless communications system 300 also includes a TRP 305, which may be an example of a TRP described with reference to FIGS. 1 and 2. The TRP 305 may be connected to a base station 105 and may provide communication coverage for geographic coverage area 110-a, which may be an example of a geographic coverage area 110 described with reference to FIG. 1. The wireless communications system 300 may implement aspects of the wireless communications system 100. For example, the wireless communications system 300 may support efficient techniques for transmitting reference signals with multiple data streams with limited overhead.

The TRP 305 and the UE 115-a may support multi-beam operation and may communicate with each other on multiple beams. In one example, the TRP 305 may transmit a first data stream using a first directional beam 315 and a second data stream using a second directional beam 320. The TRP 305 may generate the first directional beam 315 and the second directional beam 320 at a same panel or at different panels. In this example, the TRP 305 may transmit the second data stream towards an object 310, and the object 310 may deflect (e.g., reflect or refract) the second data stream to the UE 115. In other examples, the TRP 305 may transmit the first data stream using the first directional beam 315 to the UE 115, and another TRP may transmit the second data stream using a different directional beam to the UE 115. In any case, the UE 115 may receive the first data stream using a first directional beam 315 at the UE 115 and the UE 115 may receive the second data stream using a second directional beam 325 at the UE 115. The UE 115 may receive the first data stream using the first directional beam 315 and the second data stream using the second directional beam 325 on a same panel or on different panels.

In FIG. 3, to limit the overhead of reference signal transmissions, the TRP 305 may transmit reference signals associated with different streams using a same antenna port on the same resources without using CDM groups (e.g., the time and frequency resources of the reference signals associated with different streams may be the same). In particular, the TRP 305 may transmit reference signals associated with the first data stream and reference signals associated with the second data stream using a same antenna port. In some cases, selection of using CDM groups may be performed according to frequency range. For example, CDM groups may be used for carriers in some frequency ranges (e.g., FR2) while transmissions without using CDM groups may be used for carriers in other frequency ranges (e.g., FR4, FR5).

Similarly, the UE 115 may receive the reference signals associated with the first data stream and the reference signals associated with the second data stream using a same antenna port. Because a same antenna port may be used for transmitting or receiving reference signals with multiple data streams, and the reference signals may occupy the same time and frequency resources, the overhead of reference signal transmissions may be minimized. In some examples, the first and second data streams may also be transmitted over the same time-frequency resources, which may be a set of allocated time-frequency resources including the time-frequency resources used for the reference signals. That is, the TRP 305 may transmit a first transmission including the first data stream and first reference signals associated with the first data stream over a set of time-frequency resources using a first beam, and may transmit a second transmission including the second data stream and second reference signals associated with the second data stream over the set of time-frequency resources using a second beam.

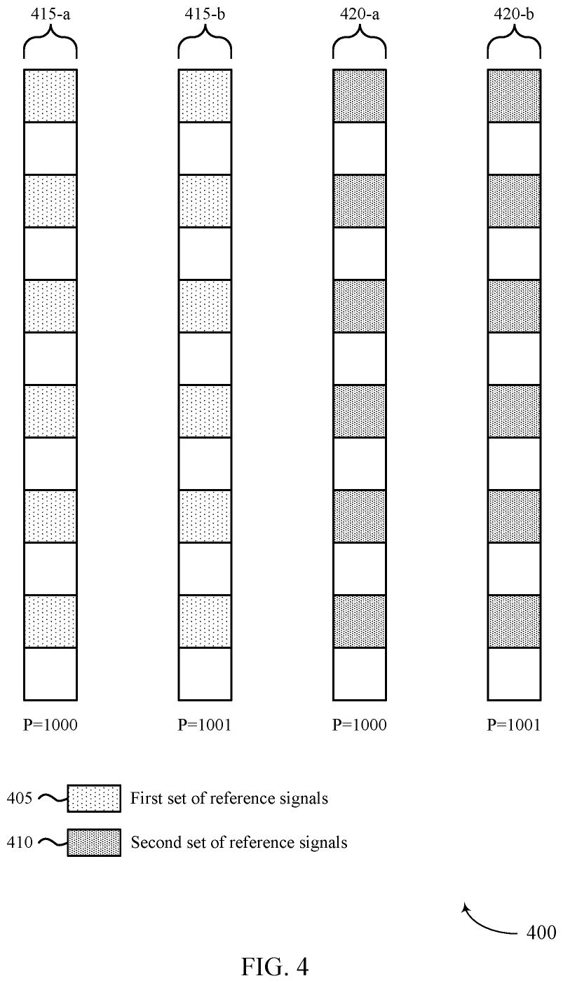

FIG. 4 illustrates an example of reference signal transmissions 400 on the same resources in accordance with aspects of the present disclosure. In higher frequency bands (e.g., FR4 or FR5), there may be much better spatial separation between beams, and a network may be able to overload DMRS ports (e.g., both streams may use antenna ports 1000 and 1001 for transmitting DMRSs). The network may transmit a first set of reference signals 405 with a first polarization 415-a (e.g., vertical) and a second set of reference signals 410 with a first polarization 420-a (e.g., vertical) in a same symbol on the same frequency resources. Similarly, the network may transmit the first set of reference signals 405 with a second polarization 415-b (e.g., horizontal) and the second set of reference signals 410 with a second polarization 420-b (e.g., horizontal) in a same symbol on the same frequency resources.

In FIG. 4, the overhead of reference signal transmissions may be reduced, resulting in improved throughput in a wireless communications system. Further, the use of the same resources for transmitting reference signal transmissions associated with multiple data streams transmitted using multiple beams may allow for a massive number of concurrent beams. That is, the use of different resources for reference signal transmissions for different beams may be limited to a number of CDM groups or number of CDM codes in each CDM group available for transmitting the reference signal transmissions. For example, using two front-loaded DMRSs may allow up to four CDM groups with a DMRS configuration type 1 and up to six CDM groups with a DMRS configuration type 2. Further, for greater than four spatial layers, two front-loaded DMRSs may be used for each spatial layer. However, using the techniques described herein, reference signal transmissions associated with different data streams may occupy the same resources (e.g., using SDM), and the overhead may be fixed (e.g., regardless of the number of layers, such that more than eight layers may be supported in a wireless communications system). As illustrated in FIG. 4, the first and second sets of reference signals may be transmitted over the same antenna ports on different beams without having CDM codes applied. Although the reference signals 405 and 410 are illustrated as using alternating or interlaced frequency resources, the reference signals 405 and 410 may use contiguous blocks of resources, in some cases. Using additional frequency resources may improve frequency resolution for demodulation at the UE 115 including improved frequency error correction and the like.

For receiving the reference signals illustrated in FIG. 4, a UE 115 may use analog or digital beamforming to separate out the different beams (e.g., a first beam carrying a first data stream and the first set of reference signals 405 and a second beam carrying a second data stream and the second set of reference signals 410). The UE 115 may perform beamforming to receive the different beams using different antenna panels, or the same antenna panel (e.g., applying a first set of coefficients associated with the first beam to a first subset of elements of the antenna panel and a second set of coefficients associated with the second beam to a second subset of elements of the antenna panel), in some cases. The UE may then use the first set of reference signals 405 for demodulation of the first data stream and the second set of reference signals 410 for demodulation of the second data stream.

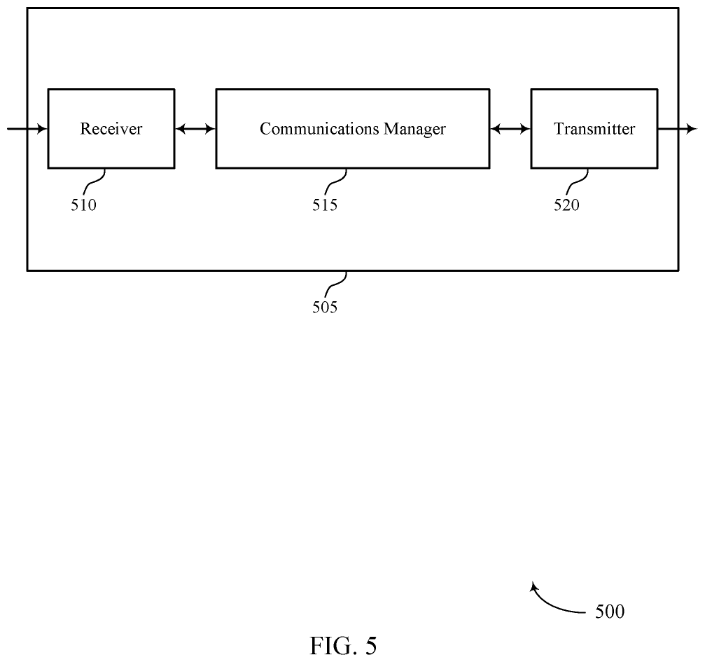

FIG. 5 shows a block diagram 500 of a device 505 that supports reference signal transmissions for multi-beam operation in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

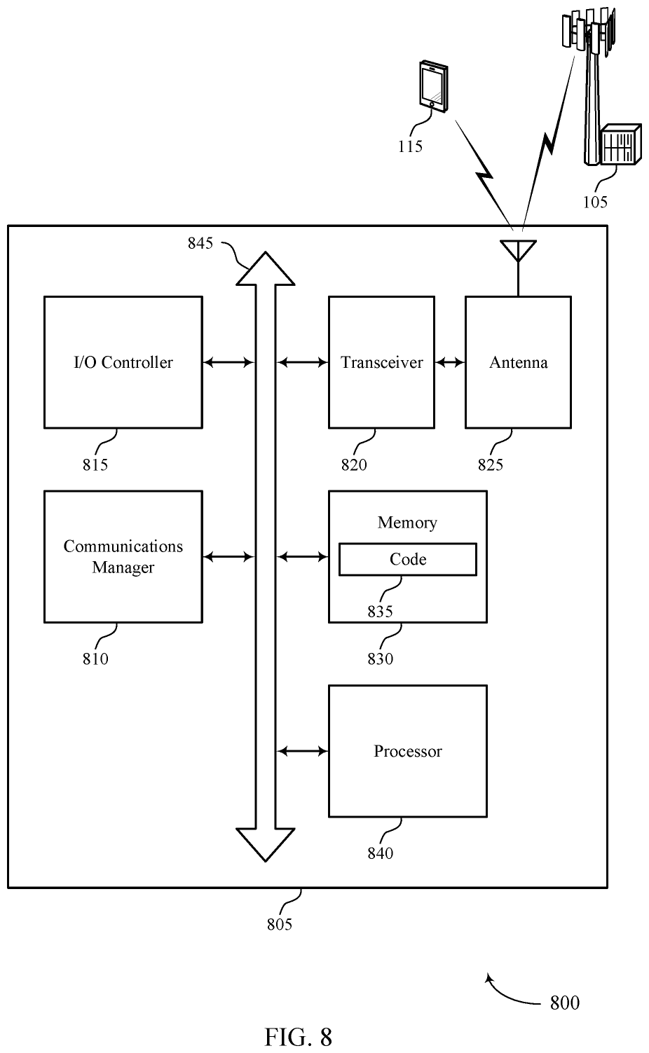

The receiver 510 may receive information such as packets, user data, or control information associated with various information channels (e.g., control channels, data channels, and information related to reference signal transmissions for multi-beam operation, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may be implemented as an integrated circuit or chipset for the device 505, and the receiver 510 and the transmitter 520 may be implemented as analog components (for example, amplifiers, filters, antennas) coupled with the device 505 modem to enable wireless transmission and reception. The actions performed by the communications manager 515 as described herein may be implemented to realize one or more potential advantages. The communications manager 515 may be an example of aspects of the communications manager 810 described herein. At least one implementation may enable the communications manager 515 to support multi-beam operation with limited overhead while maximizing the number of beams that can be used by the device 505 for communicating with another device (e.g., a base station 105).

For example, the communications manager 515 may determine a first directional beam for receiving a first data stream from a base station and a second directional beam for receiving a second data stream from the base station and receive a first reference signal associated with the first data stream via the first directional beam over an antenna port and a second reference signal associated with the second data stream via the second directional beam over the antenna port. By receiving the first reference signal and the second reference signal over the same antenna port (i.e., the antenna port), one or more processors of the device 505 (e.g., processor(s) controlling or incorporated with the communications manager 515) may experience power savings (e.g., increased battery life) since the UE may limit overhead and achieve increased throughput by using freed up resources for data, and the UE may avoid receiving the data at a later time.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

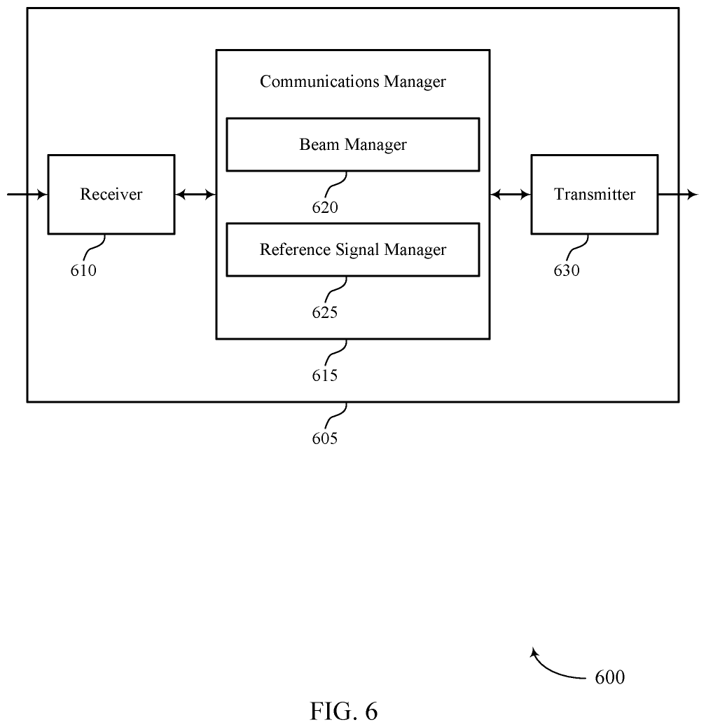

FIG. 6 shows a block diagram 600 of a device 605 that supports reference signal transmissions for multi-beam operation in accordance with aspects of the present disclosure. The device 605 may be an example of aspects of a device 505, or a UE 115 as described herein. The device 605 may include a receiver 610, a communications manager 615, and a transmitter 630. The device 605 may also include a processor. Each of these components may be in communication with one another (e.g., via one or more buses).

The receiver 610 may receive information such as packets, user data, or control information associated with various information channels (e.g., control channels, data channels, and information related to reference signal transmissions for multi-beam operation, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a beam manager 620 and a reference signal manager 625. The communications manager 615 may be an example of aspects of the communications manager 810 described herein.

The beam manager 620 may determine a first directional beam for receiving a first data stream from a base station and a second directional beam for receiving a second data stream from the base station. The reference signal manager 625 may receive a first reference signal associated with the first data stream via the first directional beam over an antenna port and a second reference signal associated with the second data stream via the second directional beam over the antenna port.

The transmitter 630 may transmit signals generated by other components of the device 605. In some examples, the transmitter 630 may be collocated with a receiver 610 in a transceiver module. For example, the transmitter 630 may be an example of aspects of the transceiver 820 described with reference to FIG. 8. The transmitter 630 may utilize a single antenna or a set of antennas.

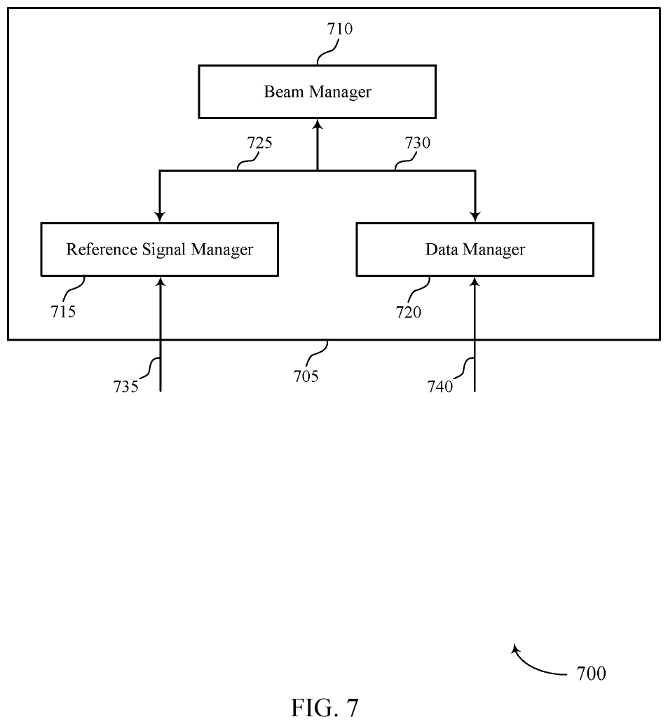

FIG. 7 shows a block diagram 700 of a communications manager 705 that supports reference signal transmissions for multi-beam operation in accordance with aspects of the present disclosure. The communications manager 705 may be an example of aspects of a communications manager 515, a communications manager 615, or a communications manager 810 described herein. The communications manager 705 may include a beam manager 710, a reference signal manager 715, and a data manager 720. Each of these modules may communicate, directly or indirectly, with one another (e.g., via one or more buses).

The beam manager 710 may determine a first directional beam for receiving a first data stream from a base station and a second directional beam for receiving a second data stream from the base station. The beam manager 710 may pass an indication 725 of the beams or antenna ports associated with the first and second directional beams to the reference signal manager 715. The reference signal manager 715 may receive reference signals 735 including a first reference signal associated with the first data stream via the first directional beam over an antenna port and a second reference signal associated with the second data stream via the second directional beam over the antenna port. In some examples, the reference signal manager 715 may receive the first reference signal and the second reference signal on a same set of time-frequency resources.

The data manager 720 may receive data transmission 740. For example, the data manager 720 may receive a first transmission over a set of time-frequency resources via the first directional beam and a second transmission over the set of time-frequency resources via the second directional beam, the first transmission including the first data stream and the first reference signal and the second transmission including the second data stream and the second reference signal. For instance, the beam manager 710 may pass an indication 730 of the beams or antenna ports associated with the first and second directional beams to the data manager 720. The data manager 720 may use the first directional beam to receive the first transmission and use the second directional beam to receive the second transmission. In some examples, the data manager 720 may receive the first transmission via the first directional beam on a first antenna panel. In some examples, the data manager 720 may receive the second transmission via the second directional beam on a second antenna panel. In some examples, the data manager 720 may receive the first transmission via the first directional beam and the second transmission via the second directional beam on a same antenna panel.

In some cases, the first reference signal and the second reference signal include demodulation reference signals, and the antenna port includes a demodulation reference signal port. In some cases, the first reference signal received via the first directional beam and the second reference signal received via the second directional beam include a same set of transmitted symbols. In some cases, each of the first data stream and the second data stream includes a set of layers.

FIG. 8 shows a diagram of a system 800 including a device 805 that supports reference signal transmissions for multi-beam operation in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may determine a first directional beam for receiving a first data stream from a base station and a second directional beam for receiving a second data stream from the base station and receive a first reference signal associated with the first data stream via the first directional beam over an antenna port and a second reference signal associated with the second data stream via the second directional beam over the antenna port.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic input/output system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting reference signal transmissions for multi-beam operation).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

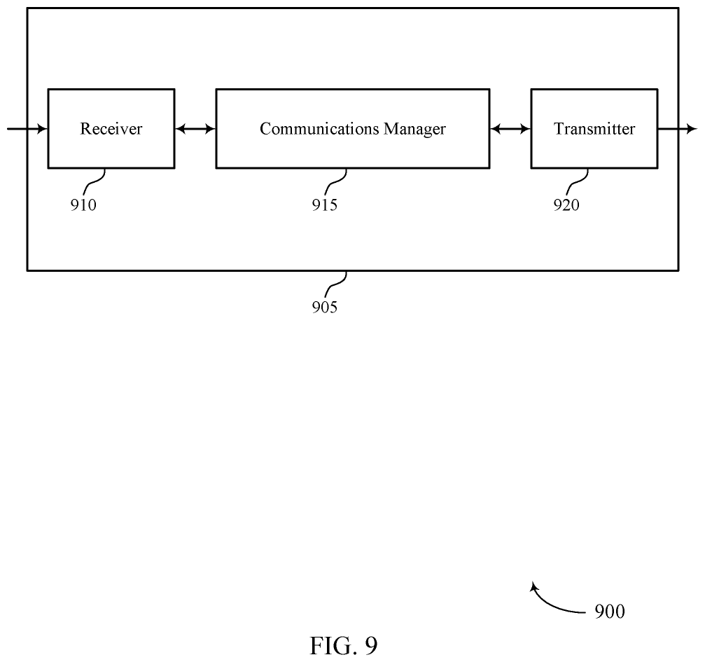

FIG. 9 shows a block diagram 900 of a device 905 that supports reference signal transmissions for multi-beam operation in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

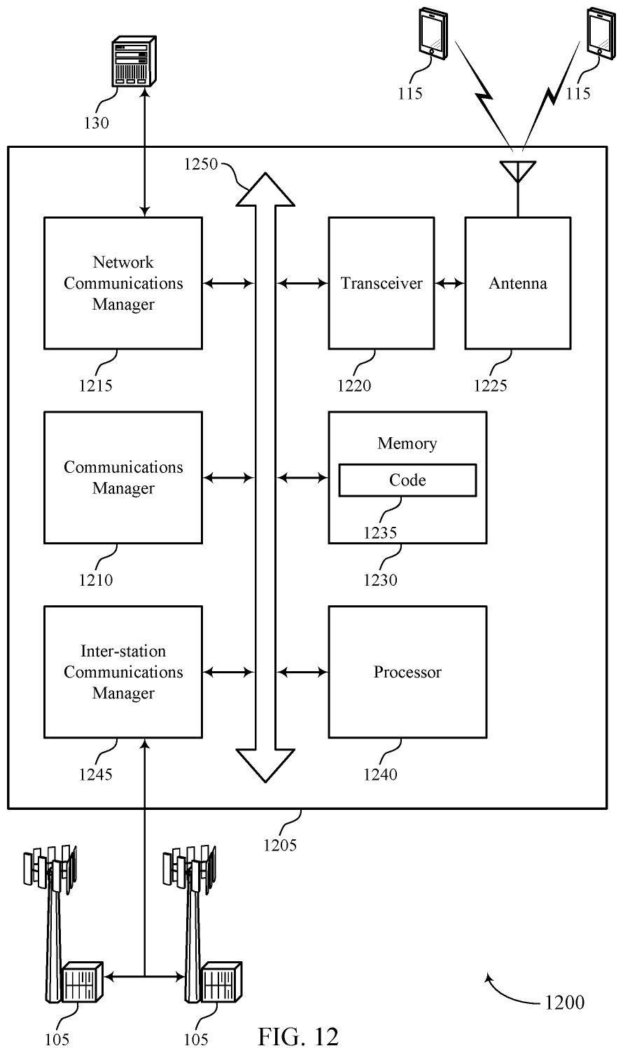

The receiver 910 may receive information such as packets, user data, or control information associated with various information channels (e.g., control channels, data channels, and information related to reference signal transmissions for multi-beam operation, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may determine a first directional beam to use to transmit a first data stream to a UE and a second directional beam to use to transmit a second data stream to the UE and transmit a first reference signal associated with the first data stream via the first directional beam over an antenna port and a second reference signal associated with the second data stream via the second directional beam over the antenna port. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), an FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

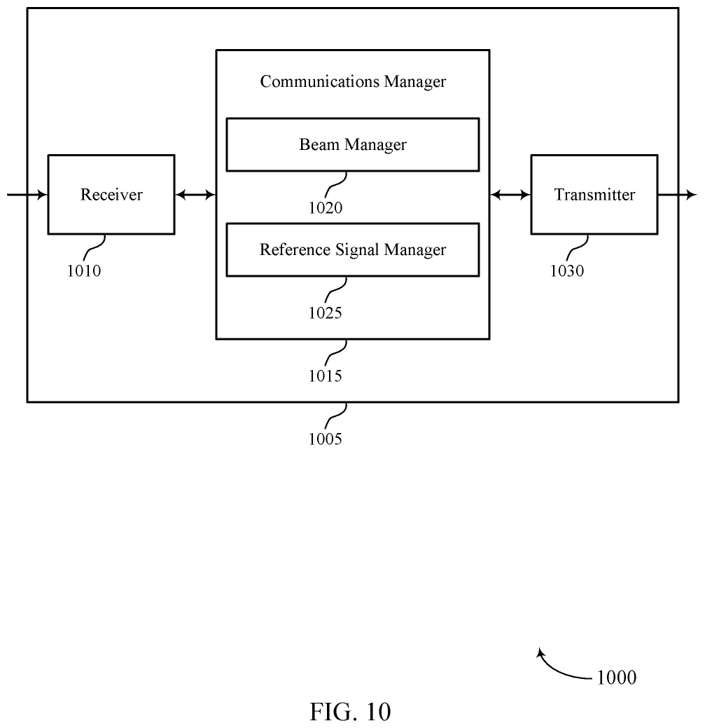

FIG. 10 shows a block diagram 1000 of a device 1005 that supports reference signal transmissions for multi-beam operation in accordance with aspects of the present disclosure. The device 1005 may be an example of aspects of a device 905, or a base station 105 as described herein. The device 1005 may include a receiver 1010, a communications manager 1015, and a transmitter 1030. The device 1005 may also include a processor. Each of these components may be in communication with one another (e.g., via one or more buses).

The receiver 1010 may receive information such as packets, user data, or control information associated with various information channels (e.g., control channels, data channels, and information related to reference signal transmissions for multi-beam operation, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a beam manager 1020 and a reference signal manager 1025. The communications manager 1015 may be an example of aspects of the communications manager 1210 described herein.

The beam manager 1020 may determine a first directional beam to use to transmit a first data stream to a UE and a second directional beam to use to transmit a second data stream to the UE. The reference signal manager 1025 may transmit a first reference signal associated with the first data stream via the first directional beam over an antenna port and a second reference signal associated with the second data stream via the second directional beam over the antenna port.

The transmitter 1030 may transmit signals generated by other components of the device 1005. In some examples, the transmitter 1030 may be collocated with a receiver 1010 in a transceiver module. For example, the transmitter 1030 may be an example of aspects of the transceiver 1220 described with reference to FIG. 12. The transmitter 1030 may utilize a single antenna or a set of antennas.

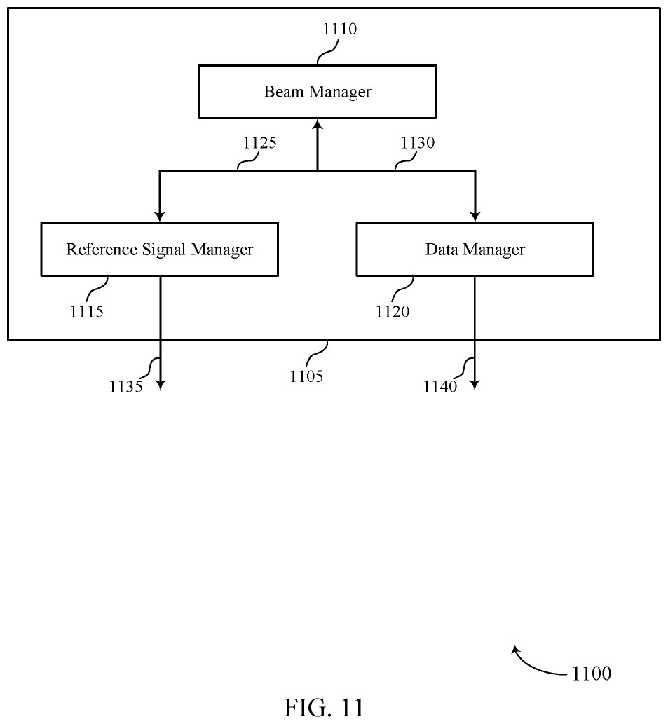

FIG. 11 shows a block diagram 1100 of a communications manager 1105 that supports reference signal transmissions for multi-beam operation in accordance with aspects of the present disclosure. The communications manager 1105 may be an example of aspects of a communications manager 915, a communications manager 1015, or a communications manager 1210 described herein. The communications manager 1105 may include a beam manager 1110, a reference signal manager 1115, and a data manager 1120. Each of these modules may communicate, directly or indirectly, with one another (e.g., via one or more buses).

The beam manager 1110 may determine a first directional beam to use to transmit a first reference signal to a UE and a second directional beam to use to transmit a second reference signal to the UE. The beam manager 1110 may pass an indication 1125 of the beams or antenna ports to use for the reference signals to the reference signal manager 1115. The reference signal manager 1115 may transmit reference signals 1135 according to the indication 1125 of the beams or antenna ports to use for the reference signals. For example, the reference signal manager 1115 may transmit a first reference signal associated with the first data stream via the first directional beam over an antenna port and a second reference signal associated with the second data stream via the second directional beam over the antenna port. In some examples, the reference signal manager 1115 may transmit the first reference signal and the second reference signal on a same set of time-frequency resources.

The data manager 1120 may transmit data signals 1140. For example, the beam manager 1110 may pass an indication 1130 of the beams or antenna ports to use for the data signals to the data manager 1120. The data manager 1120 may transmit a first transmission over a set of time-frequency resources via the first directional beam and a second transmission over the set of time-frequency resources via the second directional beam, the first transmission including the first data stream and the first reference signal and the second transmission including the second data stream and the second reference signal. In some examples, the data manager 1120 may transmit the first transmission via the first directional beam from a first transmission and reception point. In some examples, the data manager 1120 may transmit the second transmission via the second directional beam from a second transmission and reception point. In some examples, the data manager 1120 may transmit the first transmission via the first directional beam and the second transmission via the second directional beam from a same antenna panel.

In some cases, the first reference signal and the second reference signal include demodulation reference signals, and the antenna port includes a demodulation reference signal port. In some cases, the first reference signal transmitted via the first directional beam and the second reference signal transmitted via the second directional beam include a same set of transmitted symbols. In some cases, each of the first data stream and the second data stream includes a set of layers.

FIG. 12 shows a diagram of a system 1200 including a device 1205 that supports reference signal transmissions for multi-beam operation in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may determine a first directional beam to use to transmit a first data stream to a UE and a second directional beam to use to transmit a second data stream to the UE and transmit a first reference signal associated with the first data stream via the first directional beam over an antenna port and a second reference signal associated with the second data stream via the second directional beam over the antenna port.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting reference signal transmissions for multi-beam operation).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

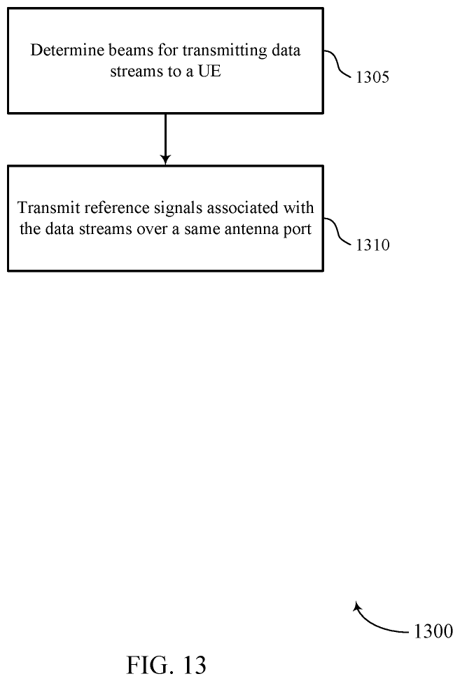

FIG. 13 shows a flowchart illustrating a method 1300 that supports reference signal transmissions for multi-beam operation in accordance with aspects of the present disclosure. The operations of method 1300 may be implemented by a base station 105 or its components as described herein. For example, the operations of method 1300 may be performed by a communications manager as described with reference to FIGS. 9 through 12. In some examples, a base station may execute a set of instructions to control the functional elements of the base station to perform the functions described below. Additionally, or alternatively, a base station may perform aspects of the functions described below using special-purpose hardware.

At 1305, the base station may determine a first directional beam to use to transmit a first data stream to a UE and a second directional beam to use to transmit a second data stream to the UE. The first directional beam and the second directional beam may be generated by different TRPs or may be generated by a same panel. The operations of 1305 may be performed according to the methods described herein. In some examples, aspects of the operations of 1305 may be performed by a beam manager as described with reference to FIGS. 9 through 12.

At 1310, the base station may transmit a first reference signal associated with the first data stream via the first directional beam over an antenna port and a second reference signal associated with the second data stream via the second directional beam over the antenna port. The base station may transmit a first transmission over a set of time-frequency resources via the first directional beam and a second transmission over the set of time-frequency resources via the second directional beam. The first transmission may include the first data stream and the first reference signal, and the second transmission may include the second data stream and the second reference signal. The base station may transmit the first and second transmissions via separate antenna panels, or via the same antenna panel, in some cases. The base station may transmit the first and second reference signals using overloading of frequency resources (e.g., without applying different CDM codes or using antenna ports associated with different CDM groups for reference signals associated with different beams). That is, the base station may transmit the first and second reference signals over a same set of resources without using different CDM codes. The operations of 1310 may be performed according to the methods described herein. In some examples, aspects of the operations of 1310 may be performed by a reference signal manager as described with reference to FIGS. 9 through 12.

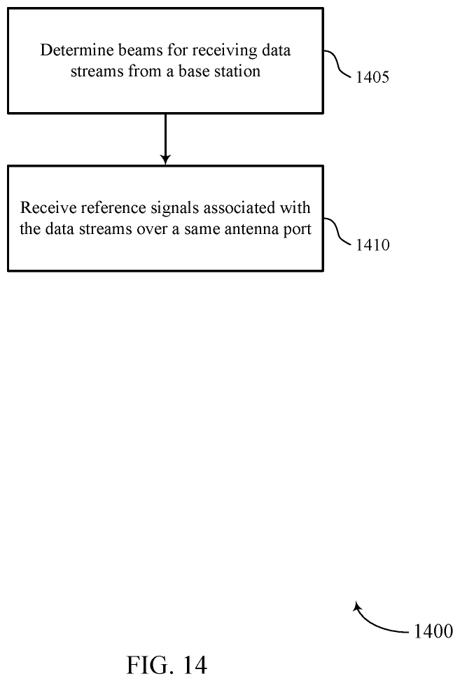

FIG. 14 shows a flowchart illustrating a method 1400 that supports reference signal transmissions for multi-beam operation in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a UE may execute a set of instructions to control the functional elements of the UE to perform the functions described below. Additionally, or alternatively, a UE may perform aspects of the functions described below using special-purpose hardware.

At 1405, the UE may determine a first directional beam for receiving a first data stream from a base station and a second directional beam for receiving a second data stream from the base station. The first directional beam and the second directional beam may be generated by different antenna panels or the same antenna panel. The operations of 1405 may be performed according to the methods described herein. In some examples, aspects of the operations of 1405 may be performed by a beam manager as described with reference to FIGS. 5 through 8.

At 1410, the UE may receive a first reference signal associated with the first data stream via the first directional beam over an antenna port and a second reference signal associated with the second data stream via the second directional beam over the antenna port. The UE may receive a first transmission over a set of time-frequency resources via the first directional beam and a second transmission over the set of time-frequency resources via the second directional beam. The first transmission may include the first data stream and the first reference signal, and the second transmission may include the second data stream and the second reference signal. The operations of 1410 may be performed according to the methods described herein. In some examples, aspects of the operations of 1410 may be performed by a reference signal manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication, comprising: determining a first directional beam to use to transmit a first data stream to a UE and a second directional beam to use to transmit a second data stream to the UE; and transmitting a first reference signal associated with the first data stream via the first directional beam over an antenna port and a second reference signal associated with the second data stream via the second directional beam over the antenna port.

Aspect 2: The method of aspect 1, wherein transmitting the first reference signal and the second reference signal over the antenna port comprises: transmitting the first reference signal and the second reference signal on a same set of time-frequency resources.

Aspect 3: The method of any of aspects 1 through 2, further comprising: transmitting a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

Aspect 4: The method of aspect 3, wherein transmitting the first transmission via the first directional beam and the second transmission via the second directional beam comprises: transmitting the first transmission via the first directional beam from a first transmission and reception point; and transmitting the second transmission via the second directional beam from a second transmission and reception point.

Aspect 5: The method of any of aspects 3 through 4, wherein transmitting the first transmission via the first directional beam and the second transmission via the second directional beam comprises: transmitting the first transmission via the first directional beam and the second transmission via the second directional beam from a same antenna panel.

Aspect 6: The method of any of aspects 1 through 5, wherein the first reference signal and the second reference signal comprise demodulation reference signals, and the antenna port comprises a demodulation reference signal port.

Aspect 7: The method of any of aspects 1 through 6, wherein the first reference signal transmitted via the first directional beam and the second reference signal transmitted via the second directional beam comprise a same set of transmitted symbols.

Aspect 8: The method of any of aspects 1 through 7, wherein each of the first data stream and the second data stream comprises a plurality of layers.

Aspect 9: A method for wireless communication at a UE, comprising: determining a first directional beam for receiving a first data stream from a base station and a second directional beam for receiving a second data stream from the base station; and receiving a first reference signal associated with the first data stream via the first directional beam over an antenna port and a second reference signal associated with the second data stream via the second directional beam over the antenna port.

Aspect 10: The method of aspect 9, wherein receiving the first reference signal and the second reference signal over the antenna port comprises: receiving the first reference signal and the second reference signal on a same set of time-frequency resources.

Aspect 11: The method of any of aspects 9 through 10, further comprising: receiving a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

Aspect 12: The method of aspect 11, wherein receiving the first transmission via the first directional beam and the second transmission via the second directional beam comprises: receiving the first transmission via the first directional beam on a first antenna panel; and receiving the second transmission via the second directional beam on a second antenna panel.

Aspect 13: The method of any of aspects 11 through 12, wherein receiving the first transmission via the first directional beam and the second transmission via the second directional beam comprises: receiving the first transmission via the first directional beam and the second transmission via the second directional beam on a same antenna panel.

Aspect 14: The method of any of aspects 9 through 13, wherein the first reference signal and the second reference signal comprise demodulation reference signals, and the antenna port comprises a demodulation reference signal port.

Aspect 15: The method of any of aspects 9 through 14, wherein the first reference signal received via the first directional beam and the second reference signal received via the second directional beam comprise a same set of transmitted symbols.

Aspect 16: The method of any of aspects 9 through 15, wherein each of the first data stream and the second data stream comprises a plurality of layers.

Aspect 17: An apparatus for wireless communication, comprising a processor; memory coupled with the processor; and instructions stored in the memory and executable by the processor to cause the apparatus to perform a method of any of aspects 1 through 8.

Aspect 18: An apparatus for wireless communication, comprising at least one means for performing a method of any of aspects 1 through 8.

Aspect 19: A non-transitory computer-readable medium storing code for wireless communication, the code comprising instructions executable by a processor to perform a method of any of aspects 1 through 8.

Aspect 20: An apparatus for wireless communication at a UE, comprising a processor; memory coupled with the processor; and instructions stored in the memory and executable by the processor to cause the apparatus to perform a method of any of aspects 9 through 16.

Aspect 21: An apparatus for wireless communication at a UE, comprising at least one means for performing a method of any of aspects 9 through 16.

Aspect 22: A non-transitory computer-readable medium storing code for wireless communication at a UE, the code comprising instructions executable by a processor to perform a method of any of aspects 9 through 16.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
determining a first directional beam to use to transmit a first data stream to a user equipment (UE) and a second directional beam to use to transmit a second data stream to the UE; and
transmitting a first reference signal associated with the first data stream via the first directional beam over an antenna port and a second reference signal associated with the second data stream via the second directional beam over the antenna port.

2. The method of claim 1, wherein transmitting the first reference signal and the second reference signal over the antenna port comprises:
transmitting the first reference signal and the second reference signal on a same set of time-frequency resources.

3. The method of claim 1, further comprising:
transmitting a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

4. The method of claim 3, wherein transmitting the first transmission via the first directional beam and the second transmission via the second directional beam comprises:
transmitting the first transmission via the first directional beam from a first transmission and reception point; and
transmitting the second transmission via the second directional beam from a second transmission and reception point.

5. The method of claim 3, wherein transmitting the first transmission via the first directional beam and the second transmission via the second directional beam comprises:
transmitting the first transmission via the first directional beam and the second transmission via the second directional beam from a same antenna panel.

6. The method of claim 1, wherein the first reference signal and the second reference signal comprise demodulation reference signals, and the antenna port comprises a demodulation reference signal port.

7. The method of claim 1, wherein the first reference signal transmitted via the first directional beam and the second reference signal transmitted via the second directional beam comprise a same set of transmitted symbols.

8. The method of claim 1, wherein each of the first data stream and the second data stream comprises a plurality of layers.

9. A method for wireless communication at a user equipment (UE), comprising:
determining a first directional beam for receiving a first data stream from a base station and a second directional beam for receiving a second data stream from the base station; and
receiving a first reference signal associated with the first data stream via the first directional beam over an antenna port and a second reference signal associated with the second data stream via the second directional beam over the antenna port.

10. The method of claim 9, wherein receiving the first reference signal and the second reference signal over the antenna port comprises:
receiving the first reference signal and the second reference signal on a same set of time-frequency resources.

11. The method of claim 9, further comprising:
receiving a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

12. The method of claim 11, wherein receiving the first transmission via the first directional beam and the second transmission via the second directional beam comprises:
receiving the first transmission via the first directional beam on a first antenna panel; and
receiving the second transmission via the second directional beam on a second antenna panel.

13. The method of claim 11, wherein receiving the first transmission via the first directional beam and the second transmission via the second directional beam comprises:
receiving the first transmission via the first directional beam and the second transmission via the second directional beam on a same antenna panel.

14. The method of claim 9, wherein the first reference signal and the second reference signal comprise demodulation reference signals, and the antenna port comprises a demodulation reference signal port.

15. The method of claim 9, wherein the first reference signal received via the first directional beam and the second reference signal received via the second directional beam comprise a same set of transmitted symbols.

16. The method of claim 9, wherein each of the first data stream and the second data stream comprises a plurality of layers.

17. An apparatus for wireless communication, comprising:
a processor,
memory coupled with the processor; and
instructions stored in the memory and executable by the processor to cause the apparatus to:
determine a first directional beam to use to transmit a first data stream to a user equipment (UE) and a second directional beam to use to transmit a second data stream to the UE; and
transmit a first reference signal associated with the first data stream via the first directional beam over an antenna port and a second reference signal associated with the second data stream via the second directional beam over the antenna port.

18. The apparatus of claim 17, wherein the instructions to transmit the first reference signal and the second reference signal over the antenna port are executable by the processor to cause the apparatus to:
transmit the first reference signal and the second reference signal on a same set of time-frequency resources.

19. The apparatus of claim 17, wherein the instructions are further executable by the processor to cause the apparatus to:
transmit a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

20. The apparatus of claim 19, wherein the instructions to transmit the first transmission via the first directional beam and the second transmission via the second directional beam are executable by the processor to cause the apparatus to:
transmit the first transmission via the first directional beam from a first transmission and reception point; and
transmit the second transmission via the second directional beam from a second transmission and reception point.

21. The apparatus of claim 19, wherein the instructions to transmit the first transmission via the first directional beam and the second transmission via the second directional beam are executable by the processor to cause the apparatus to:
transmit the first transmission via the first directional beam and the second transmission via the second directional beam from a same antenna panel.

22. The apparatus of claim 17, wherein the first reference signal and the second reference signal comprise demodulation reference signals, and the antenna port comprises a demodulation reference signal port.

23. The apparatus of claim 17, wherein the first reference signal transmitted via the first directional beam and the second reference signal transmitted via the second directional beam comprise a same set of transmitted symbols.

24. The apparatus of claim 17, wherein each of the first data stream and the second data stream comprises a plurality of layers.

25. An apparatus for wireless communication at a user equipment (UE), comprising:
a processor,
memory coupled with the processor; and
instructions stored in the memory and executable by the processor to cause the apparatus to:
determine a first directional beam for receiving a first data stream from a base station and a second directional beam for receiving a second data stream from the base station; and
receive a first reference signal associated with the first data stream via the first directional beam over an antenna port and a second reference signal associated with the second data stream via the second directional beam over the antenna port.

26. The apparatus of claim 25, wherein the instructions to receive the first reference signal and the second reference signal over the antenna port are executable by the processor to cause the apparatus to:
receive the first reference signal and the second reference signal on a same set of time-frequency resources.

27. The apparatus of claim 25, wherein the instructions are further executable by the processor to cause the apparatus to:
receive a first transmission over a set of time-frequency resources via the first directional beam and a second transmission over the set of time-frequency resources via the second directional beam, the first transmission comprising the first data stream and the first reference signal and the second transmission comprising the second data stream and the second reference signal.

28. The apparatus of claim 27, wherein the instructions to receive the first transmission via the first directional beam and the second transmission via the second directional beam are executable by the processor to cause the apparatus to:
receive the first transmission via the first directional beam on a first antenna panel; and
receive the second transmission via the second directional beam on a second antenna panel.

29. The apparatus of claim 27, wherein the instructions to receive the first transmission via the first directional beam and the second transmission via the second directional beam are executable by the processor to cause the apparatus to:
receive the first transmission via the first directional beam and the second transmission via the second directional beam on a same antenna panel.

30. The apparatus of claim 25, wherein the first reference signal and the second reference signal comprise demodulation reference signals, and the antenna port comprises a demodulation reference signal port.
